(19) United States
(12) Patent Application Publication
(10) Pub. No.: US 2026/0109024 A1
(43) Pub. Date: Apr. 23, 2026

(54) WEARABLE ROBOT

(71) Applicants: Hyundai Motor Company, Seoul (KR); Kia Corporation, Seoul (KR)

(72) Inventors: Seok Ryung KWON, Hwaseong-Si (KR); Ju Young YOON, Hwaseong-Si (KR); Ho Jun KIM, Hwaseong-Si (KR); Hyun Seop LIM, Hwaseong-Si (KR); Kyu Jung KIM, Hwaseong-Si (KR)

(21) Appl. No.: 19/210,159

(22) Filed: May 16, 2025

(30) Foreign Application Priority Data
Oct. 21, 2024 (KR) 10-2024-0144380

(51) Int. Cl. B25J 9/00

(52) U.S. Cl. CPC B25J 9/0006

(57) ABSTRACT

A wearable robot includes a support member having a portion configured to be tightly attached to a rear surface portion of a wearer, a rotary member provided at one side of the support member, coupled to the support member, and configured to be rotatable about a rotary shaft, and a wire member provided on the rear surface portion of the wearer and having one side configured to pass over the rotary member. The rotary member includes a first rotational region provided at one side of the rotary shaft and configured to be tightly attached and fixed to the rear surface portion of the wearer, and a second rotational region provided at the other side of the rotary shaft and configured to define a section over which the wire member passes.

### CROSS-REFERENCE TO RELATED APPLICATION

This application claims priority to and the benefit of Korean Patent Application No. 10-2024-0144380 filed in the Korean Intellectual Property Office on Oct. 21, 2024, the entire contents of which are incorporated herein by reference.

### TECHNICAL FIELD

The present disclosure relates to a wearable robot, and more particularly, to a wearable robot capable of assisting muscular strength of a wearer.

### BACKGROUND

Wearable robots, which generate assistive power (e.g., for assisting muscular strength of wearers), are broadly classified into hard-type and soft-type wearable robots. A hard-type wearable robot generates assistive power, which suits a change in posture of the wearer, by/via a power source such as a motor. A soft-type wearable robot generates assistive power by/via a change in relative position between components in a structure for generating the assistive power. Among the wearable robots, the soft-type wearable robot provides excellent wearing comfort in comparison with the hard-type wearable robot, but the soft-type wearable robot provides a smaller magnitude of assistive power. For this reason, there is a problem in that usefulness of the soft-type wearable robot is relatively low when the wearable robot is provided to assist muscular strength of a body part that requires relatively high muscular strength, like muscular strength of a waist (e.g., and/or hips).

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a wearable robot and/or device. A wearable robot may comprise a brace configured to be attached to a rear surface of a wearer; a lever coupled to the brace and configured to be rotatable about a rotary shaft, wherein the lever comprises: a first rotational region provided at a first side of the rotary shaft and configured to be fixed to the rear surface of the wearer; and a second rotational region provided at a second side of the rotary shaft, opposite to the first side, and configured to be at a fixed orientation relative to the first rotational region; and a wire, attached to the rear surface of the wearer, and configured to pass over the second rotational region.

Also, or alternatively, a wearable device may comprise: a back support configured to be fit to a rear surface of a wearer; a protrusion configured to extend from the back support away from the rear surface of the wearer and comprising a rotary shaft; a lever configured to be rotatable about the rotary shaft and comprising: a first rotational region, configured to be fixed relative to a portion of the rear surface of the wearer; and a second rotational region configured to extend from the rotary shaft at a fixed angle relative to the first rotational region; and a wire configured to be attached to the wearer so as to have a tension applied in a direction and to be supported away from the rear surface of the wearer by the second rotational region.

Also, or alternatively, a wearable device may comprise: a rotary shaft configured to be positioned a set distance from a rear surface of a wearer of the wearable device; a lever configured to be rotatable about the rotary shaft and comprising: a first rotational region, extending in a first direction from the rotary shaft, comprising a ring configured to be fixed to a portion of the rear surface of the wearer; and a second rotational region extending in a second direction from the rotary shaft, wherein the second direction is at a fixed angle relative to the first rotational region; and a wire, attached to the wearer at a position superior to a waist of the wearer and at a position inferior to the waist of the wearer and supported away from the rear surface of the wearer by the second rotational region.

These and other features and advantages are described in greater detail below.

### BRIEF DESCRIPTION OF THE DRAWINGS

FIG. 1 is a view illustrating a state in which a wearer wears a wearable robot according to the present disclosure.

FIG. 2 is an enlarged perspective view illustrating a support member and a rotary member of the wearable robot illustrated in FIG. 1.

FIG. 3 is an enlarged side view illustrating the support member and the rotary member of the wearable robot illustrated in FIG. 1.

FIG. 4 is a view illustrating a state in which the wearer, who wears the wearable robot according to the present disclosure, stands.

FIG. 5 is a view illustrating a state in which the wearer, who wears the wearable robot according to the present disclosure, bends his/her waist and/or hips.

### DETAILED DESCRIPTION

Unless otherwise defined, the terms used herein, including technical or scientific terms, may have meanings generally understood by those skilled in the art to which the present disclosure belongs.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of” is synonymous with “at least one of” herein.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

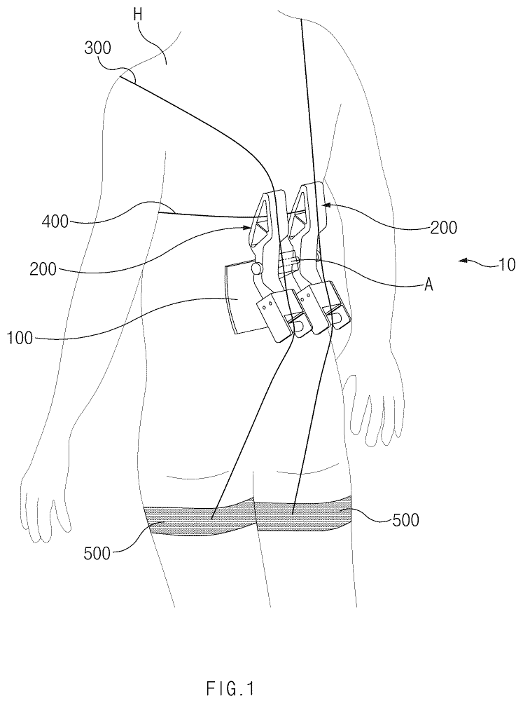

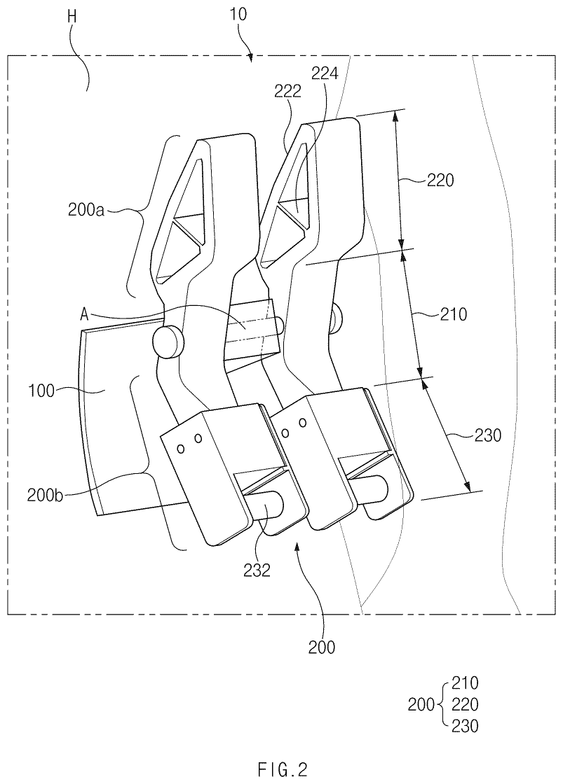

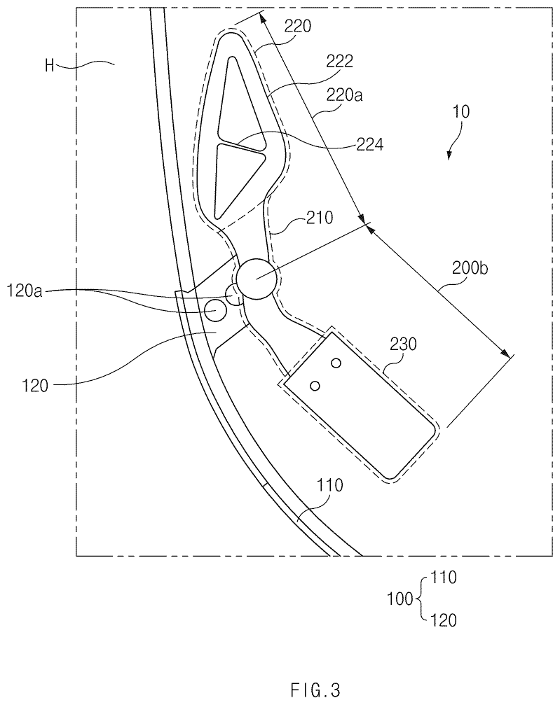

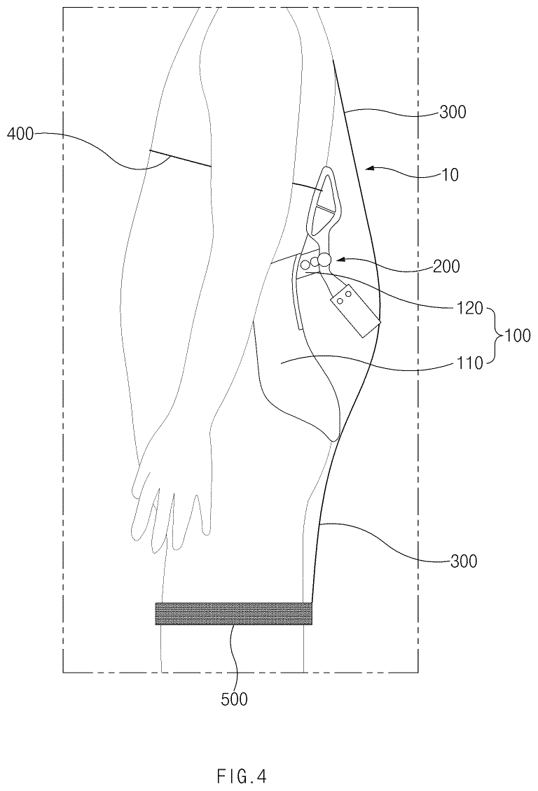

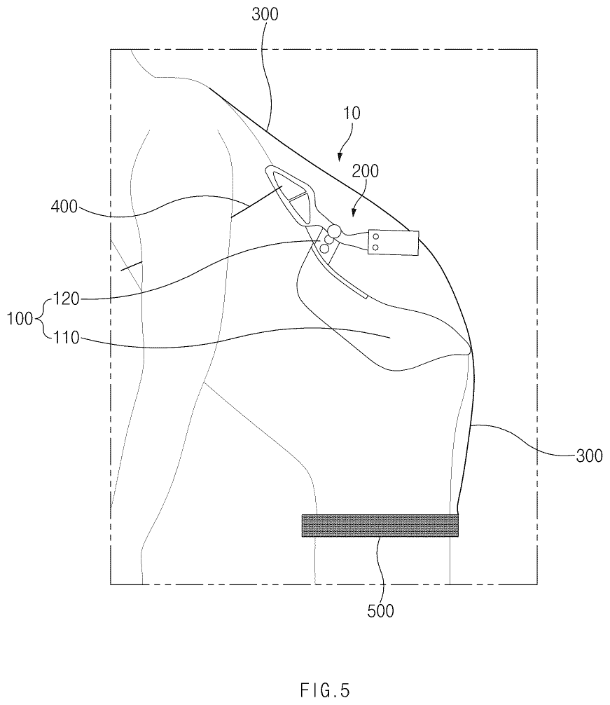

FIG. 1 is a view illustrating a state in which a wearer wears a wearable robot according to the present disclosure, and FIG. 2 is an enlarged perspective view illustrating a support member and a rotary member of the wearable robot illustrated in FIG. 1. FIG. 3 is an enlarged side view illustrating the support member and the rotary member of the wearable robot illustrated in FIG. 1, and FIG. 4 is a view illustrating a state in which the wearer, who wears the wearable robot according to the present disclosure, stands. FIG. 5 is a view illustrating a state in which the wearer, who wears the wearable robot according to the present disclosure, bends his/her waist.

A wearable device 10 (e.g., a wearable robot) (e.g., a wearable strength assistance device) according to the present disclosure may be a device that serves to assist muscular strength of a wearer. For example, the wearable robot 10 may be a device that serves to assist waist and/or hip muscular strength of a wearer. The wearable robot 10, when worn by the user, may generate a force in a direction in which the wearer stretches his/her waist and/or hips when bending at the waist and/or hips, thereby assisting waist muscular strength of the wearer. Herein, bending at the waist and assisting waist muscular strength of a wearer will be discussed, but one skilled in the art will understand the disclosed wearable robot 10 assists in muscular strength in a user bending at the waist, hips, and/or otherwise through their trunk.

For example, the wearable robot 10 may assist waist muscular strength of the wearer by using an elastic force (e.g., of a wire having elasticity). For example, the wearable robot 10 according to the present disclosure may increase the assistive power for assisting muscular strength with the elastic force of the wire by maximizing/increasing a degree to which the wire is extended when the wearer bends his/her waist.

The wearable robot according to the present disclosure may be a device for assisting muscular strength when the wearer wears the wearable robot. Therefore, the wearable robot according to the present disclosure will be described with reference to the state in which the wearer wears the wearable robot based on the original purpose of the wearable robot. An upward/downward direction, a leftward/rightward direction, and a forward/rearward direction of the wearable robot are also defined on the basis of the state in which the wearer wears the wearable robot.

The wearable robot 10 according to the present disclosure may include a support member 100 (e.g., a support, a support structure, a back support, a brace, a back brace, etc.) including a portion configured to be tightly attached to a rear (e.g., back, dorsal, anterior) surface portion of a wearer H. For example, the support member 100 may be configured to be tightly attached to a back of the waist of the wearer H and/or tightly attached to a part of the back of the waist and/or buttock. The support member 100 may be configured to be tightly attached and fixed to the wearer H regardless of a posture of the wearer H when the wearer H wears the wearable robot 10 (e.g., consistently tightly attached and fixed to the wearer H).

The wearable robot 10 according to the present disclosure may include rotary members 200 (e.g., rotary devices) configured to be rotatable relative to the support member 100. The wearable robot 10 according to the present disclosure may further include the rotary members 200 provided at one side of the support member 100, coupled to the support member 100, and configured to be rotatable about a rotary shaft A. The rotary member 200 (e.g., a lever, a lever structure) may be configured to rotate (e.g., about the rotary shaft A) relative to the support member 100 in accordance with a change in posture of the wearer H of the wearable robot 10. A change in relative position between the support member 100 and the rotary member 200 may occur in accordance with the change in posture of the wearer H. For example, at least a part of the rotary member 200 may be provided to face the support member 100 (e.g., in the forward/rearward direction).

The wearable robot 10 according to the present disclosure may include wire member(s) 300 (e.g., wire(s)) each at least partially provided on the wearer (e.g., each at least partially provided on the rear surface portion of the wearer H, each configured to be at least partially anchored on/to the wearer). Each of the wire members 300 may also pass over the rotary member 200 (e.g., at least a portion of the wire members 300 may pass over/be supported by the rotary members 200). The wire member 300 may comprise and/or be made of an elastic material (e.g., capable of generating an elastic force when stretched/deformed). The wire member 300 may be stretched when the wearer H bends his/her waist (e.g., due to being anchored/connected to the wearer H, such as at a point above the waist and another point below the waist. The assistive power for assisting the waist muscular strength of the wearer H may be generated by the elastic force of the stretched wire member 300. To this end, a first side/first end of the wire member 300 may be fixed/anchored to an upper body of the wearer H (e.g., a portion of the body of the wearer above the waist of the wearer H), and a second side/second end of the wire member 300 may be fixed to a lower body of the wearer H (e.g., at a portion of the body of the wearer H below the waist of the wearer H). The first end and the second end of the wire member 300 may be fixed so as to apply tension to the wire member 300 (e.g., over the.

The wearable robot 10 of the present disclosure may adopt a structure for increasing the assistive power for assisting the muscular strength afforded by using the wire member 300. The wearable robot 10 of the present disclosure may increase a moment arm by increasing a degree to which the wire member 300 and the wearer H move away from each other, thereby increasing a degree to which the wire member 300 is stretched when the wearer H bends his/her waist. Increasing the degree to which the wire member 300 is stretched increases an elastic force generated by the stretching, thereby increasing the assistive power of the wearable robot 10.

The rotary member 200 may include a first rotational region 200a provided at one side of the rotary shaft A and configured to be (e.g., tightly) attached to the rear surface portion of the wearer H. The rotary member 200 may include a second rotational region 200b provided at the other side of the rotary shaft A and configured to define/comprise a section over which the wire member 300 passes. The first rotational region 200a and the second rotational region 200b may be fixed to each other. For example, the first rotational region 200a and the second rotational region 200b may be integrated. The first rotational region 200a may be provided to a first side of the rotary shaft A, and the second rotational region 200b may be provided to a second side of the rotary shaft A. For example, the first rotational region 200a and the second rotational region 200b may be configured such that, when the wearable robot is worn by a wearer, the first rotational region 200a is above and/or towards a head of the wearer H relative to (e.g., superior to) the rotary shaft A and the second rotational region 200b is below and/or towards legs of the wearer H relative to (e.g., inferior to) the rotary shaft A. The first rotational region 200a and the second rotational region 200b may be at a fixed orientation and/or angle relative to each other, such that if the first rotational region 200a rotates a certain angle about the rotary shaft A (e.g., with bending of the wearer H at the waist), the second rotational region 200b also rotates the certain angle about the rotary shaft A (e.g., away from a lower portion of the wearer H).

The wearable robot 10 according to the present disclosure may further include a configuration configured to (e.g., tightly) attach and/or fix one side of the rotary member 200 to the rear surface portion of the wearer H. The wearable robot 10 according to the present disclosure may further include an upper strap member 400 (e.g., an upper strap, one or more upper straps) configured such that at least one side thereof is attached to and/or passes through the first rotational region 200a. The upper strap member 400 may be configured to press the first rotational region 200a against the rear surface portion of the upper body of the wearer H. For example, the upper strap member surround the rear surface portion, a lateral surface portion, and a front surface portion of the wearer H and to secure the first rotational region 200a to the rear surface portion of the upper body of the wearer H. If the wearer H bends his/her waist in the state in which the wearer H wears the wearable robot 10 with the upper strap member 400 pressing the first rotational portion 200a to the rear surface portion of the upper body of the wearer H (e.g., if the upper strap member 400 surrounds the rear surface portion of the upper body of the wearer H), the first rotational region 200a (e.g., which is tightly attached and/or fixed to the rear surface portion of the upper body of the wearer H), may be moved forward by tension of the upper strap member 400 in response to the motion of the wearer H. The second rotational region 200b, which is provided to an opposite side of the rotary shaft A to the first rotational region 200a, may be moved in a direction away from the rear surface portion of the wearer H. For example, the wire member 300 may pass over the second rotational region 200b, such that a portion of the wire member 300, which passes over the second rotational region 200b, is also moved in the direction away from the rear surface portion of the wearer H (e.g., by the motion of the second rotational region 200b; see, for example, FIGS. 4 and 5). This configuration may not only stretch the wire member 300 further, but also increase a distance between the wire member 300 and the wearer H, thereby increasing the moment arm of the force applied by the wire member 300. Therefore, according to the present disclosure, it is possible to more effectively assist the waist muscular strength of the wearer H. The drawings illustrate a state in which the first rotational region 200a is positioned above the support member 100 so that the first rotational region 200a is tightly attached and fixed to the wearer H.

With continued reference to the drawings, the wearable robot 10 according to the present disclosure may include lower strap members 500 (e.g., one or more lower straps) provided below the support member 100 and the rotary members 200 and configured to be (e.g., tightly) attached to the lower body of the wearer H (e.g., at legs of the wearer) so that an second end of the wire member 300 is fixed to the lower strap members 500. This may allow for smoothly stretching the wire member 300, for example, by fixing one end of the wire member 300 relative to the lower body of the wearer H, if the wearer H bends and/or straightens his/her waist.

The rotary member 200 may have a shape corresponding to a shape of the waist of the wearer H (e.g., when/where the wearer H wears the wearable robot 10 on their body). The rotary member 200 may have an overall shape recessed toward a front side of the wearer H (e.g., curved to match a curve of the back of the wearer H). This may be to minimize/reduce discomfort and/or interference between the rotary member 200 and the waist of the wearer by allowing the rotary member 200 to have a shape similar to the shape of the waist of the wearer.

The support member 100 may comprise a plurality of regions (e.g., be conceptualized as having a plurality of regions). The support member 100 may include a support body 110 configured to be tightly attached to the rear surface portion of the wearer H, and/or an extension region 120 (e.g., a protrusion) extending rearward from the support body 110. A plurality of holes 120a may be formed in the extension region 120. The rotary shaft A may be inserted into at least one of the plurality of holes 120a. The configuration in which the plurality of holes 120a are formed in the extension region 120 may be provided to couple the rotary shaft A selectively to one of the plurality of holes 120a, for example, in consideration of a body type of the wearer H, a magnitude of assistive power required by the wearer H to assist the waist muscular strength, and the like. For example, the magnitude of assistive power may depend at least in part upon how far from the wearer H's backTo this end, the plurality of holes 120a may each have a size and a shape so that the rotary shaft A may be selectively inserted into one of the plurality of holes 120a.

The rotary member 200 may be divided into a plurality of sections. The rotary member 200 may include a first section 210 having a shape recessed toward the front side of the wearer H and/or having one side into which the rotary shaft A is inserted. the rotary member 200 may include a second section 220 provided at an upper side of the first section 210 (e.g., towards a first side of the first section 210 configured to be towards a head of the wearer H when the wearable robot 10 is worn). The second section 220 may be configured to define the above-mentioned first rotational region 200a (e.g., together with a part of the first section 210). The second section 220 may include a ring portion 222 (e.g., a ring, a loop, etc. configured to accept the upper strap member 400, and/or another connector configured to accept and/or be fixed to the upper strap member 400). The second section may include a third section 230 provided at a lower side of the first section 210 (e.g., at a second side of the first section 210 configured to be away from a head of the wearer H and/or towards legs of the wearer H when the wearable robot 10 is worn). The third section 230 may be configured to define the above-mentioned second rotational region 200b together with the other part of the first section 210. The third section 230 may include a rod portion 232 (e.g., a rod) extending in the leftward/rightward direction of the wearer H (e.g., configured to extend in the leftward/rightward direction of the wearer H when the wearable is worn by the wearer H). An upper region of the first section 210 and the second section 220 may define the above-mentioned first rotational region 200a, and a lower region of the first section 210 and the third section 230 may define the above-mentioned second rotational region 200b. As illustrated in the drawings, for example, a point on the first section 210, which has the shape recessed toward the front side of the wearer H, may be provided below the rotary shaft A (e.g., toward legs of the wearer H).

According to the present disclosure, the upper strap member 400 may be provided to penetrate (and/or be otherwise attached to) the ring portion 222 of the second section 220. Therefore, the second section 220 and/or the first rotational region 200a may be tightly attached and/or fixed to the rear surface portion of the wearer H by the upper strap member 400 through and/or attached to the ring portion 222. In addition to the ring portion 222, the second section 220 may include a partition wall portion 224 configured to divide an internal space, which is formed by the ring portion 222, in the upward/downward direction (e.g., superior/inferior direction). In this case, the upper strap member 400 may selectively penetrate an upper space (e.g., first space and/or superior space) and/or lower space (e.g., second space and/or inferior space) of the partition wall portion 224 in the internal space formed by the ring portion 222.

The wire member 300 may be provided to pass over the rod portion 232 of the third section 230. For example, the wire member 300 may be supported by the rod portion of the third section. The wire member 300 may be bent about the rod portion 232 (e.g., when the wearable robot 10 is worn by the wearer H). Therefore, when the wearer H bends his/her waist in the state (e.g., while wearer H wears the wearable robot 10) a distance between the wearer H and the portion of the wire member 300, which passes over the rod portion 232, may be increased (e.g., as the third section 230 moves away from/protrudes further from the wearer H), which may increase the moment arm.

The rotary member(s) 200 and the wire member(s) 300 provided in the wearable robot 10, according to the present disclosure, may be respectively provided as a plurality of rotary members 200 and a plurality of wire members 300. The plurality of rotary members 200 may be spaced apart from one another in the leftward/rightward direction of the wearer H, and the plurality of wire members 300 may be spaced apart from one another in the leftward/rightward direction of the wearer H (e.g., to correspond to the plurality of rotary members 200). The rotary shaft A may be provided to penetrate the plurality of rotary members 200. For example, the plurality of rotary members 200 may have the same shape and size, and the plurality of wire members 300 may have the same shape and size. Also, or alternatively, the rotary member(s) 200 may comprise a plurality of third sections 230 (e.g., to correspond to the plurality of wire members 300.

The present disclosure has been made in an effort to provide a new type of wearable robot having a structure capable of increasing assistive power for assisting muscular strength of a wearer.

One aspect of the present disclosure provides a wearable robot including: a support member including a portion configured to be tightly attached to a rear surface portion of a wearer; a rotary member provided at one side of the support member, coupled to the support member, and configured to be rotatable about a rotary shaft A; and a wire member at least partially provided on the rear surface portion of the wearer and having one side configured to pass over the rotary member, in which the rotary member includes: a first rotational region provided at one side of the rotary shaft A and configured to be tightly attached and fixed to the rear surface portion of the wearer; and a second rotational region provided at the other side of the rotary shaft A, configured to define a section over which the wire member passes, and fixed relative to the first rotational region.

The wearable robot may further include: an upper strap member configured such that one side thereof passes through the first rotational region, the upper strap member being configured to surround the rear surface portion, a lateral surface portion, and a front surface portion of the wearer and press the first rotational region against the rear surface portion of the wearer.

The first rotational region may be provided above the rotary shaft A, and the second rotational region may be provided below the rotary shaft A.

The wearable robot may further include: a lower strap member provided below the support member and the rotary member, configured to be tightly attached to a lower body of the wearer, and having one side to which the wire member is fixed.

The first rotational region is positioned above the support member 100.

The rotary member may have an overall shape recessed toward a front side of the wearer.

The support member may include: a support body configured to be tightly attached to the rear surface portion of the wearer; and an extension region extending rearward from the support body, a plurality of holes may be formed in the extension region, and the plurality of holes may each have a size and a shape so that the rotary shaft is selectively inserted into one of the plurality of holes.

The rotary member may include: a first section having a shape recessed toward a front side of the wearer and having one side into which the rotary shaft A is inserted; and a second section provided at an upper side of the first section, configured to define the first rotational region together with a part of the first section, and including a ring portion, and the upper strap member may penetrate the ring portion of the second section.

The second section may further include a partition wall portion configured to divide an internal space formed by the ring portion.

The rotary member may further include a third section provided at a lower side of the first section, configured to define the second rotational region together with the other part of the first section, and including a rod portion extending in a leftward/rightward direction of the wearer, and the wire member may be configured to pass over the rod portion.

The rotary member may be provided as a plurality of rotary members spaced apart from one another in a leftward/rightward direction of the wearer, the wire member may be provided as a plurality of wire members spaced apart from one another in the leftward/rightward direction of the wearer, and the rotary shaft A may penetrate the plurality of rotary members.

The plurality of rotary members may have the same shape and size.

A point on the first section, which has a shape recessed toward a front side of the wearer, may be provided below the rotary shaft A.

According to the present disclosure, it is possible to provide the new type of wearable robot having the structure capable of increasing the assistive power for assisting the muscular strength.

The present disclosure has been described with reference to the limited examples and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A wearable robot comprising:
a brace configured to be attached to a rear surface of a wearer;
a lever coupled to the brace and configured to be rotatable about a rotary shaft,
wherein the lever comprises:
a first rotational region provided at a first side of the rotary shaft and configured to be fixed to the rear surface of the wearer; and
a second rotational region provided at a second side of the rotary shaft, opposite to the first side, and configured to be at a fixed orientation relative to the first rotational region; and
a wire, attached to the rear surface of the wearer, and configured to pass over the second rotational region.

2. The wearable robot of claim 1, further comprising:
an upper strap configured to:
pass through the first rotational region to surround:
the rear surface;
a lateral surface of the wearer; and
a front surface of the wearer; and
press the first rotational region against the rear surface of the wearer.

3. The wearable robot of claim 2, wherein, when the wearable robot is worn by the wearer, the first rotational region is configured to be superior to the rotary shaft, and the second rotational region is configured to be inferior to the rotary shaft.

4. The wearable robot of claim 1, further comprising:
a lower strap configured to be, when the wearable robot is worn by the wearer, attached to a portion of a lower body of the wearer at a location inferior to the brace and the lever, wherein the wire is fixed to the lower strap.

5. The wearable robot of claim 1, wherein the first rotational region is configured to be, when the wearable robot is worn by the wearer, superior to the brace.

6. The wearable robot of claim 1, wherein the lever is configured to be, when the wearable robot is worn by the wearer, recessed toward a front side of the wearer.

7. The wearable robot of claim 1, wherein the brace comprises:
a support body configured to be attached to the rear surface of the wearer; and
an extension region extending rearward from the support body,
wherein a plurality of holes are formed in the extension region and
wherein each hole of the plurality of holes is configured to accept insertion of the rotary shaft.

8. The wearable robot of claim 2, wherein the lever comprises:
a first section configured to be, when the wearable robot is worn by the wearer, recessed toward a front side of the wearer and comprising at least one hole configured to accept insertion of the rotary shaft; and
a second section provided at a first side of the first section and comprising a ring configured to be penetrated by the upper strap, wherein the second section is configured to be superior to the first section when the wearable robot is worn by the wearer.

9. The wearable robot of claim 8, wherein the second section further comprises a partition wall configured to divide an internal space formed by the ring.

10. The wearable robot of claim 8, wherein the lever further comprises a third section:
provided at a second side, opposite to the first side, of the first section, and
comprising a rod configured to extend in a lateral direction of the wearer when the wearable robot is worn by the wearer, wherein the wire is configured to pass over the rod.

11. The wearable robot of claim 1, wherein:
the lever is provided as a plurality of rotary structures spaced apart from each other in a direction corresponding to a lateral direction of the wearer when the wearer is wearing the wearable robot,
the wire is provided as a plurality of wires spaced apart from one another in the lateral direction to correspond to the plurality of rotary structures, and
the rotary shaft is inserted into the plurality of rotary structures.

12. The wearable robot of claim 11, wherein the plurality of rotary structures each have a same shape and size.

13. The wearable robot of claim 8, wherein the first section is configured to be, when the wearable robot is worn by the wearer, recessed toward the front side of the wearer in a region inferior to the rotary shaft.

14. A wearable device comprising:
a back support configured to be fit to a rear surface of a wearer;
a protrusion configured to extend from the back support away from the rear surface of the wearer and comprising a rotary shaft;
a lever configured to be rotatable about the rotary shaft and comprising:
a first rotational region, configured to be fixed relative to a portion of the rear surface of the wearer; and
a second rotational region configured to extend from the rotary shaft at a fixed angle relative to the first rotational region; and
a wire configured to be attached to the wearer so as to have a tension applied in a direction and to be supported away from the rear surface of the wearer by the second rotational region.

15. The wearable device of claim 14, wherein the second rotational region is configured to extend when the wearer bends forward at a waist or a hip of the wearer, and wherein an extension of the second rotational region is configured to increase the tension.

16. The wearable device of claim 14, wherein the wire is attached to the wearer at a position superior to a waist of the wearer and at a position inferior to the waist of the wearer, and wherein the wire comprises an elastic material.

17. A wearable device comprising:
a rotary shaft configured to be positioned a set distance from a rear surface of a wearer of the wearable device;
a lever configured to be rotatable about the rotary shaft and comprising:
a first rotational region, extending in a first direction from the rotary shaft, comprising a ring configured to be fixed to a portion of the rear surface of the wearer; and
a second rotational region extending in a second direction from the rotary shaft, wherein the second direction is at a fixed angle relative to the first rotational region; and
a wire, attached to the wearer at a position superior to a waist of the wearer and at a position inferior to the waist of the wearer and supported away from the rear surface of the wearer by the second rotational region.

18. The wearable device of claim 17, further comprising:
a back brace for back support configured to be fit to the rear surface of the wearer; and
a protrusion configured to extend from the back brace away from the rear surface of the wearer, wherein the protrusion forms one or more holes configured to accept the rotary shaft.

19. The wearable device of claim 17, wherein the wire comprises an elastic material.

20. The wearable device of claim 19, wherein the fixed angle causes the second rotational region to protrude away from the wearer when the first rotational region is fixed to the portion of the rear surface of the wearer.
